(19) United States
(12) Patent Application Publication
(10) Pub. No.: US 2025/0094760 A1
(43) Pub. Date: Mar. 20, 2025

(54) DATA CARRIER IN CARD FORM AND METHOD FOR PRODUCING A DATA CARRIER IN CARD FORM

(71) Applicant: Giesecke+Devrient ePayments GmbH, Munich (DE)

(72) Inventors: Klaus KOHL, Munich (DE); Peter TARANTINO, Munich (DE); Thomas TARANTINO, Munich (DE)

(21) Appl. No.: 18/884,743

(22) Filed: Sep. 13, 2024

(30) Foreign Application Priority Data
Sep. 15, 2023 (DE) 102023125072.8

(51) Int. Cl. G06K 19/077; B42D 25/346; B42D 25/387; B42D 25/40

(52) U.S. Cl. CPC G06K 19/0772; B42D 25/346; B42D 25/387; B42D 25/40

(57) ABSTRACT

A data carrier in card form includes a card body, which has a first card surface, a second card surface, and a peripheral border. The peripheral border connects the first card surface to the second card surface. The peripheral border also has a first border portion with at least one cutout, with at least one cutout being at least partially filled with a color material, in order in this way to provide a color effect for the first border portion. A method is provided for producing a data carrier in card form.

### FIELD OF THE INVENTION

The present invention relates to the provision of color effects in the case of data carriers in card form. The invention relates in particular to a data carrier in card form, to the use of such a data carrier in card form as an identification document, an identity document, a chip card or a payment card, and also to a method for producing a data carrier in card form.

### BACKGROUND OF THE INVENTION

Nowadays, data carriers in card form are used in many application areas. For example, such data carriers can be used for cashless payment for goods or services, for personalized proof of identity or for accessing Internet-based application programs. Accordingly, there are for example data carriers in card form in the form of chip cards in general, payment cards, such as for example credit cards or debit cards, and also personal ID or identity cards. These data carriers in card form usually have a layered structure, with electronics, coils and contact interfaces for communication with external readers being integrated in the layered structure. Data carriers in card form are also provided with various, externally visible colors, in order to provide a color effect or a color impression for a viewer looking at the data carrier in card form. The colors may in this case be provided in the form of printed layers in the data carrier in card form or else as printed coatings on a surface of the data carrier in card form. Effects of wear, such as for example abrasion of the color at the surface regions, can however reduce the color effect over time.

### SUMMARY

One object of the present invention is to provide a data carrier in card form which retains a color effect over longer time periods.

This object is achieved by the subject matter of the independent claims. The dependent claims and the following description provide embodiments by way of example.

According to one aspect, a data carrier in card form is provided. The data carrier in card form comprises a card body, which has a first card surface, a second card surface and a peripheral border. The peripheral border connects the first card surface to the second card surface. The peripheral border has a first border portion with at least one cutout, with the at least one cutout being at least partially filled with a color material, in order in this way to provide a color effect for the first border portion.

With the data carrier in card form according to the invention it is possible by geometrical shaping of a border region of the card body to provide a receiving region for receiving the color material, which offers protection for the color material received, so that even under the stress of external factors the color material is worn away less. In particular, precisely defined cutouts in which the color material is incorporated are provided in the border region, with the recessed subregions formed by the cutouts being protected by means of adjacent raised parts.

Generally, data carriers in card form, in particular payment cards, are in daily use. For example, a credit card or a debit card is pushed into a card reader to initiate a payment process. When the data carrier in card form is pushed into a reader, often the surfaces, in particular the edges and borders, of the data carrier in card form come into contact with parts of the reader, which exacerbates an abrasive effect in these regions of the data carrier in card form. Consequently, effects of wear occur over time, in the course of which color layers on the surface can be gradually removed. Even when a payment card is just being carried in a wallet or purse, wear may occur because of the continual movement of the card in the wallet or purse.

In order therefore to reduce the wear of the color material at least in the border region of the data carrier in card form, in the case of the inventive data carrier in card form the color material is received in the at least one cutout. This may mean that the color material has been introduced into the cutout, for example in the form of a color application or color inlay, and an accumulation of the color material forms there. This accumulation of the color material is abraded less under the stress of external factors, since it is unlikely that pointed objects will penetrate this cutout and thereby damage or remove the color material in the cutout.

The at least one cutout may comprise a multiplicity of cutouts, which are arranged in a distributed manner along the peripheral border. It is however also possible that only a single cutout is provided, extending partially or completely along the peripheral border.

The peripheral border may be formed by a number of border portions, which together define a length and a width of the card body. In a plan view of the card body, it has for example a rectangular form. The peripheral border may in this case define the lateral terminations or ends of the card body, with the peripheral border being formed in the form of a wall which extends substantially perpendicularly to the first card surface and/or the second card surface. In this wall of the peripheral border, the cutout may be provided in the form of a depression, notch, channel, hollow, groove, etc. There may also be a number of such geometrical formations provided in the peripheral border.

The peripheral border has the first border portion, in which the at least one cutout is provided. The border portion may be part of the peripheral border, in particular a straight border portion of the card body which defines a first lateral end of the card body.

The at least one cutout is partially or completely filled with the color material. When it is completely filled with the color material, the cutout is filled up completely by the color material, so that an outer area of the first border portion assumes a planar or smooth form. When it is not completely filled with the color material, a recessed part of the cutout may not be completely filled, so that lateral delimitations of the cutout are raised up slightly from the color material. These raised delimitations can be felt by a user of the data carrier in card form, so that a haptic effect is also obtained for the user by means of the cutout partially filled with color material.

The color material may contain an arrangement of one or more color components. In other words, the color material may have the effect that a viewer looking at the data carrier in card form perceives one or more colors in the first border portion of the card body when they look at the data carrier in card form. In this way, the color effect can be provided for the first border portion. In the event that a number of color components are provided in the cutout, the viewer may see different colors in the first border portion.

Advantageously, the color material has not just been applied to the border of the card body but has been introduced into the at least one cutout in the border of the card body, so that the color material is better protected from external mechanical influences. Various types and forms of cutouts may be provided here, explained more precisely below.

The data carrier in card form may be considered as a card element, which may be of a sheet-like form and may be constructed in a number of layers, which are created in a laminating process during the production of the card element. The card body may be produced in this way. For example, the card body may have a base structure and a surface layer, i.e. a so-called overlay. The card body may likewise comprise one or a multiplicity of security feature(s), such as a security chip, in the region of the card element surface, etc.

Similarly, an electronic contact interface may be provided, provided in the region of the first card surface. A coil or an antenna element may similarly be embedded in the card body, in order in this way to provide a contactless interface of the data carrier in card form.

According to one embodiment, the at least one cutout is provided in the form of a depression in the first border portion, extending perpendicularly to the first card surface and/or the second card surface.

In this case, a depression wall of the depression, which represents a termination of the card body in the first border portion, may be arranged substantially perpendicularly to the first card surface and/or the second card surface. The wall may in this case be formed in the form of half a cylinder lateral surface. It is also possible for a multiplicity of such depressions or depression walls extending perpendicularly to the first and/or second card surface to be provided in the border portion.

According to one embodiment, the at least one cutout is provided in the form of a depression in the first border portion, extending from the first card surface to the second card surface.

In other words, the depression, and consequently the depression wall extending perpendicularly to the first and/or second card surface, may extend over the entire thickness of the card body. In a plan view of the first and/or second card surface, the depression would therefore be visible as a lateral notch or hollow. In the event that a multiplicity of such cutouts are provided in the form of corresponding depressions, a ribbed structure in the region of the first border portion of the card body may be presented to a viewer looking at the first and/or second card surfaces in a plan view. This ribbed structure may ultimately also provide a haptic effect for the user. This is so because the raised regions of this ribbed structure can be felt by the user, in particular if the cutouts are not completely filled with color material. The ribbed structure formed by a number of cutouts adjacent to one another may extend along the entire peripheral border, that is to say along a number of border portions.

According to one embodiment, the at least one cutout is provided in the form of an elongate depression in the first border portion, extending parallel to the first card surface and/or to the second card surface.

In this case, a depression wall of the elongate depression that represents a termination of the card body in the first border portion may extend substantially parallel to the first card surface and/or to the second card surface. The wall may in this case be formed in the form of an elongate hollow, channel or groove. In a side view looking in a direction parallel to the first and/or second card surface, the elongate depression would therefore be visible as a lateral hollow, channel or groove. The elongate depression may extend along the entire peripheral border, that is to say along a number of border portions.

According to one embodiment, the at least one cutout has in a cross section parallel to the first card surface and/or to the second card surface a curved form, a rectangular form or a triangular form. The curved form may in this case have a semicircular form or a parabolic form. In addition or as an alternative to this, the at least one cutout has in a cross section perpendicular to the first card surface and/or to the second card surface a curved form, a rectangular form or a triangular form. The curved form may in this case have a semicircular form or a parabolic form.

A wide variety of forms may be provided for the cutout, with the color material received or incorporated within the cutout in a protected manner. In particular, the cutout may be formed in such a way that the likelihood of an object being able to penetrate into the cutout, and thereby remove the color material from the cutout, is very small. Typically, if the color material were simply only applied to a planar surface or outer area of a border of the card body, part of the color material would possibly be removed every time there is contact with surrounding objects. The data carrier in card form according to the invention can effectively counteract precisely this disadvantage, since the color material is arranged in a protected manner within the cutout or the cutouts.

According to one embodiment, the at least one cutout is defined by a lowered part and two raised parts, with the two raised parts being adjacent to the lowered part and with the color material being provided at least in the lowered part.

This type of formation of the cutout protects the color material in the first border portion of the data carrier in card form from wear or abrasion. The two raised parts and the lowered part may be formed by delimiting walls of the cutout, with the delimiting walls defining the cutout per se.

The raised parts as it were shield the lowered part, so that an object approaching the border portion of the card body would first come into contact with one or both raised parts. The object therefore does not get into the lowered part, or at least not completely, so that the object does not come into contact with the color material, or only to a small extent, and possibly remove it from the lowered part.

According to one embodiment, the first border portion has a multiplicity of cutouts, which are arranged at regular distances from one another along the first border portion, with each cutout of the multiplicity of cutouts being at least partially filled with a color material, in order in this way to provide the color effect for the first border portion.

It may be provided that each cutout of the multiplicity of cutouts is completely filled with the color material, in order in this way to provide the color effect for the first border portion. In particular, an outer area formed by the color material and outwardly directed surfaces of the raised parts of the cutout may finish flush. The first border portion may consequently form a completely planar or smooth surface. However, it may also be provided that the outwardly directed surfaces of the raised parts are covered by color material. Similarly it may be provided that the outwardly directed surfaces of the raised parts protrude slightly from the color material, so that a ribbed structure is obtained in the first border portion, which in turn achieves a haptic effect for the user.

According to one embodiment, the peripheral border has the first border portion, a second border portion, a third border portion and a fourth border portion, with the first border portion lying opposite the third border portion with respect to the card body and with the second border portion lying opposite the fourth border portion with respect to the card body.

The card body may in other words have four straight border regions, with a border portion being provided in each border region or each border region forming a border portion. The four border portions may together form the peripheral border of the card body. The features and properties that are explained above and below with reference to the first border portion may also apply to the second, third and fourth border portions. In particular, at least one cutout but also a multiplicity of cutouts, as described herein, may be provided in some of or a number of the border portions mentioned.

According to one embodiment, the at least one cutout extends along the first border portion, the second border portion, the third border portion and the fourth border portion.

The cutout may in this case be an elongate cutout in the form of a groove, channel or hollow that extends parallel to the first and/or second card surface. Since the first, second, third and fourth border portions may together form the peripheral border, the elongate cutout may extend along the entire peripheral border. In this way, the color material may be provided along the entire peripheral border in the cutout extending there, so that the color effect is provided at the entire peripheral border region of the card body.

According to one embodiment, the color material is an ultraviolet-radiation-curing (UV-curing) printing ink. The color may therefore have been introduced into the border portion by means of a printing process. A spraying process or a painting process, for example dip coating, are however likewise possible.

According to one aspect, a use of the data carrier in card form described herein as an identification document, an identity document, a chip card or a payment card is intended.

According to one aspect, a method for producing a data carrier in card form is provided. In one step of the method, a card body is provided, having a first card surface, a second card surface and a peripheral border, with the peripheral border connecting the first card surface to the second card surface. In a further step, at least one cutout is provided in a first border portion of the peripheral border. In a further step, a color material is introduced into the at least one cutout, in order in this way to provide a color effect for the first border portion that is perceptible for a user of the data carrier in card form. The method steps can be carried out in the sequence specified.

According to one embodiment, the provision of the at least one cutout in the first border portion of the peripheral border takes place during a punching out of the card body.

In this case, the card body may be punched out from a semifinished card body blank, while, by corresponding shaping of the punching tool, the cutouts can at the same time be introduced into the card body.

According to one embodiment, the provision of the at least one cutout in the first border portion of the peripheral border may take place by means of a laser process or a milling process.

For example, the cutouts may be introduced into the first border portion by milling or lasering after the card body has been punched out from the semifinished card body blank.

According to one embodiment, the introduction of the color material into the at least one cutout takes place by means of a printing process or a spraying process.

The introduction of the color material may take place after the provision of the at least one cutout in the border portion.

### BRIEF DESCRIPTION OF THE DRAWINGS

FIG. 1 shows a plan view of a first card surface of a card body of a data carrier in card form.

FIG. 2 shows a side view of the card body from FIG. 1.

FIG. 3 shows a plan view of part of the first card surface from FIG. 1, with color application in a border portion of the card body.

FIG. 4 shows cutouts with color material received therein in a border portion of the card body from FIG. 1.

FIG. 5 shows a view of a detail of two cutouts from FIG. 4.

FIG. 6 shows a further plan view of the card body from FIG. 1.

FIG. 7 shows a cross-sectional view of the card body from FIG. 6.

FIG. 8 shows a cross section, given by way of example, of a border portion of the card body from FIG. 6.

FIG. 9 shows a further cross section, given by way of example, of a border portion of the card body from FIG. 6.

FIG. 10 shows a tool for producing the card body of FIGS. 4 and 5.

FIG. 11 shows a tool for producing the card body of FIG. 7 and a corresponding cross section of a tool part.

FIG. 12 shows a flow diagram for a method for producing a data carrier in card form.

### DETAILED DESCRIPTION OF THE INVENTION

The representations in the figures are schematic and not to scale. If the same reference signs are used in various figures in the following description of the figures, these reference signs denote identical or similar elements. However, identical or similar elements may also be denoted by different reference signs.

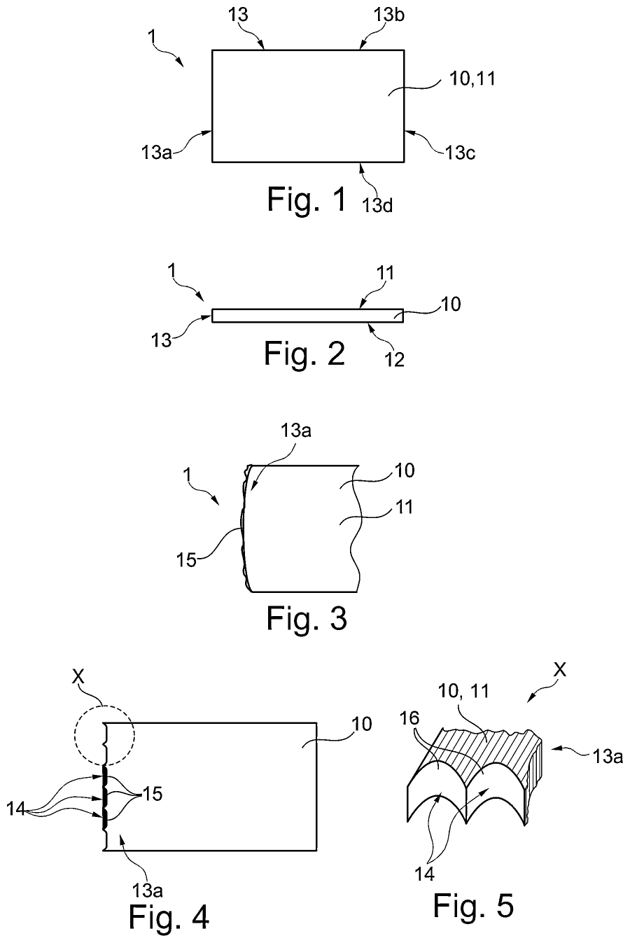

FIG. 1 shows a plan view of a first card surface 11 of a card body 10 of a data carrier 1 in card form. The card body 10 has a peripheral border 13, which is formed by four straight border portions 13a, 13b, 13c, 13d. The peripheral border 13 comprises in particular a first border portion 13a, a second border portion 13b, a third border portion 13c and a fourth border portion 13d. These four border portions 13a, 13b, 13c, 13d together form the peripheral border 13. The first border portion 13a lies opposite the third border portion 13c relative to the card body 10 and the second border portion 13b lies opposite the fourth border portion 13d relative to the card body. The card format shown in FIG. 1 is formed, for example an ID-1 format.

FIG. 2 shows a side view of the card body 10 of the data carrier 1 in card form from FIG. 1, with only part of the peripheral border 13 being shown. As can be seen, the card body 10 has a first card surface 11 and a second card surface 12, with the peripheral border 13 connecting the first card surface 11 to the second card surface 12.

FIG. 3 shows a plan view of part of the first card surface 11 from FIG. 1, with color material 15 or color application in the first border portion 13a of the card body 10. The irregular course of the line in the region of the first border portion 13a is intended to indicate a removal of color material in some subregions of the first border portion 13a. Such removals or abrasion are the result of continual everyday stresses to which the data carrier 1 in card form is subjected. The edge or the border may be uneven and the color applied is exposed to mechanical stresses during daily use of the data carrier 1 in card form. For example, when the data carrier 1 in card form is inserted into a card reader, the edge or the border of the card body 10 of the data carrier 1 in card form is subjected to strong mechanical stresses and as a result the color is gradually worn away. According to the invention, it is therefore intended that one or more cutouts are provided in the region of the first border portion 13a, or else in the region of the further border portions 13b, 13c, 13d of the card body 10, with the color material being received or incorporated in these cutouts.

FIG. 4 shows cutouts 14, with color material 15 received or incorporated therein, in the first border region 13a of the card body 10 from FIG. 1. It can be seen that the cutouts 14 form a ribbed structure in the first border portion 13a in a plan view of the card body 10. In the example shown in FIG. 4, precisely three neighboring cutouts 14 are filled with color material 15. It should be understood however that more or fewer cutouts 14 in the border portion 13a may be filled with color material 15. In particular, all of the cutouts 14 may be filled with color material 15.

It can also be seen in FIG. 4 that the filling of the cutouts 14 with color material 15 has the effect of creating a substantially planar surface in the border portion 13a. In other words, the cutouts 14 may be filled with color material 15 in such a way as to create a substantially planar or smooth surface in the first border portion 13a. A broken circle in FIG. 4, which is denoted by X, indicates a region of a detail of the first border portion 13a, which is explained more precisely with reference to FIG. 5.

FIG. 5 therefore shows the view of the detail X from FIG. 4. The two cutouts 14 in this view of a detail are not filled with color material 15 for purposes of explanation. The two cutouts 14 are provided in the form of depressions in the first border portion 13a of the card body 10, with the depressions extending perpendicularly to the first card surface 11, that is to say in FIG. 5 from top to bottom or vice versa. In this example, the depressions even extend over the entire thickness of the card body 10, that is to say from the first card surface 11 to the second card surface 12, which is not shown in FIG. 5 (cf. FIG. 2).

The depressions may be defined by respective depression walls 16, which define an outer termination of the card body 10 in the first border portion 13a. The depression walls 16 are formed here similarly to a half cylinder lateral surface. There may be a multiplicity of such depressions or depression walls 16 extending perpendicularly to the first and/or second card surface 11, 12 provided in the first border portion 13a, or else also in the further border portions 13b, 13c, 13d (cf. FIG. 1).

The cutouts 14 may be created for example during a punching out of the card body 10 from a semifinished blank. Alternatively, the cutouts 14 may be created after the card body 10 has been punched out or individually separated, for example by means of laser, milling or similar processes. Then the color material 15 may be introduced into the cutouts 14 (cf. FIG. 4). The color material 15 may for example be introduced by means of a spraying process or by means of a digital printer with a UV-curing ink system. The color material 15 is then as it were recessed in the cutouts 14, and thereby better protected from external mechanical influences. The cutouts 14 in FIGS. 4 and 5 are only given by way of example and may assume any desired form.

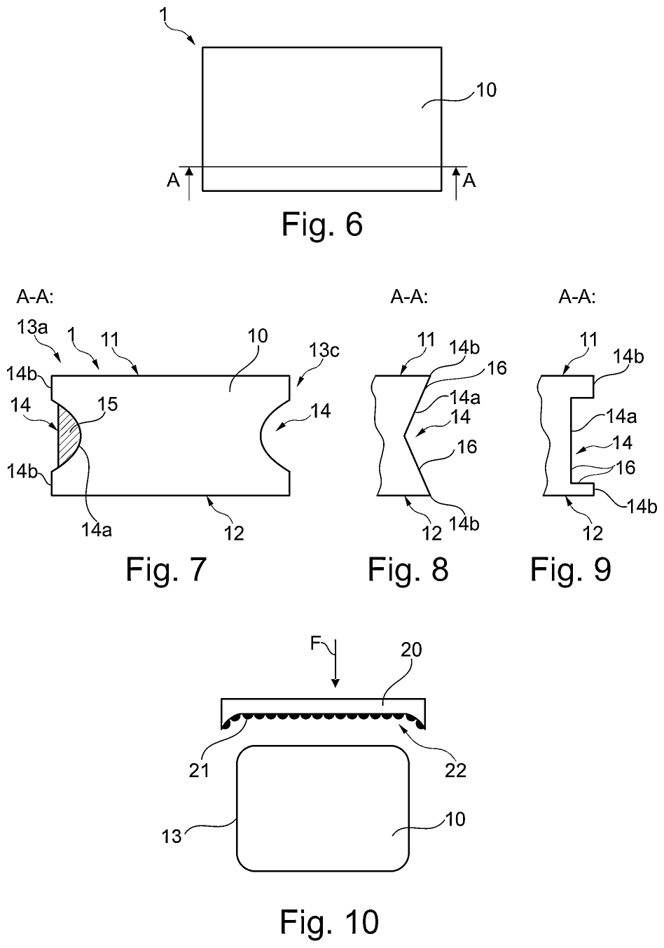

FIG. 6 shows a further plan view of the card body 10 from FIG. 1, with a section line through the card body 10 of the data carrier 1 in card form being indicated here. This section line is intended to indicate a section A-A through the card body 10, which is explained more precisely with reference to FIG. 7

FIG. 7 therefore shows the cross-sectional view A-A of the card body 10 from FIG. 6. In the cross section A-A through the data carrier 1 in card form, the card body 10, the first card surface 11, the second card surface 12 and one or two cutouts 14 are provided.

In the case of a single cutout 14, this cutout 14 extends parallel to the first and second card surfaces 11, 12 around the entire card body 10. In the cross section A-A shown in FIG. 7, the cutout 14 can however only be seen in the region of the first border portion 13a and in the region of the opposite third border portion 13c. The single cutout 14 is an elongate cutout 14 in the form of a hollow, channel, furrow or groove, which extends along the peripheral border 3 of the card body 10 completely around it (cf. FIG. 1).

In the case of a number of cutouts 14, the cutout 14 shown on the left in the first border portion 13a and the cutout 14 shown on the right in the third border portion 13c are two different cutouts 14. In this case, there is thus not a single cutout 14 extending around the entire periphery of the card body 10.

In FIG. 7 it can also be seen that the cutout 14 provided in the first border portion 13a is partially filled with color material 15, in order to provide a color effect in the first border portion 13a for a viewer. In other words, the viewer can see the color introduced by the color material 15 in the cutout 14. By recessing the color material 15 in the cutout 14, the color material 15 can be better protected from external influences, in particular from mechanical influences.

This protection can be ensured by the cutout 14 being defined by a lowered part 14a and two raised parts 14b, with the two raised parts 14b being adjacent to the lowered part 14a and the color material 15 being arranged in the lowered part 14a. The color material 15 is consequently as it were incorporated in a recessed manner in the lowered part 14a, with the neighboring raised parts 14b offering a kind of shielding for the color material 15 in the lowered part 14a. If for example an object such as a card reader is brought up close to the card body 10, this object first or exclusively comes into contact with one or both of the raised parts 14b. The object therefore does not get into the lowered part 14a, or at least not completely, so that the object does not come into contact, or only to a slight extent, with the color material 15, and possibly damages it or removes it from the lowered part 14a. Here, too, the color material 15 may for example be introduced by means of a spraying process or by means of a digital printer with a UV-curing ink system. The color material 15 is then as it were recessed in the cutouts 14 and as a result better protected from external mechanical influences.

FIG. 8 shows a cross section, given by way of example, of a border portion of the card body 10 from FIG. 1. This border portion may be formed by one or more of the first, second, third or fourth border portions 13a, 13b, 13c, 13d. The raised parts 14b and the lowered part 14a can be seen, with the corresponding walls 16 defining the cutout 14. The walls 16 may also be referred to as depression walls 16 of the cutout 14. Shown in FIG. 8 is a triangular cutout 14, which extends in the border portion between the first and second card surfaces 11, 12.

FIG. 9 shows a further cross section, given by way of example, of the border portion of the card body 10 from FIG. 1. This border portion may be formed by one or more of the first, second, third or fourth border portions 13a, 13b, 13c, 13d. Once again the raised parts 14b and the lowered part 14a can be seen, with the corresponding walls 16 defining the cutout 14. Shown in FIG. 9 is a rectangular or groove-shaped cutout 14, which extends in the border portion between the first and second card surfaces 11, 12.

FIG. 10 shows a tool 20 for producing the card body 10 from FIGS. 4 and 5. The tool 20 may have a die with an embossing surface 22, with the embossing surface 22 having a multiplicity of projections 21, protuberances 21 or shapings 21, which ultimately define the form of the cutouts 14, as shown in FIGS. 4 and 5, in the card body 10. During the production process, the tool 20 may be moved toward the punched-out card body 10 and then pressed against the border 13 of the card body 10. For this purpose, the force F indicated by the arrow is applied, whereby the projections 21 are pressed into part of the peripheral border 13 of the card body 10.

In FIG. 10, only one side is shown by way of example. Four tools 20 may be provided, respectively creating the cutouts 14 in one of the border portions 13a, 13b, 13c, 13d (cf. FIG. 1). It is also possible however for two tools 20 to be provided, respectively positioned in an L shape around the card body 10 in such a way that one of the two tools 20 introduces the cutouts 14 for example into the first border portion 13a and into the second border portion 13b and the other of the two tools 20 introduces the cutouts 14 for example into the third border portion 13c and into the fourth border portion 13d (cf. once again FIG. 1).

During the production process, the tool 20 may be stationary and the card body 10 may be turned with respect to the tool 20. In this case, the card body 10 is moved up to the tool 20, in order to provide the structure predetermined by the projections 21 in the form of the cutouts 14 in the card body 10. The form and the specific shaping of the cutouts 14 are determined by the tool 20, in particular by the projections 21. The embossing may be performed cold in the production process, or the tool 20 may be heated or activated by ultrasound. This can make the embossing process easier.

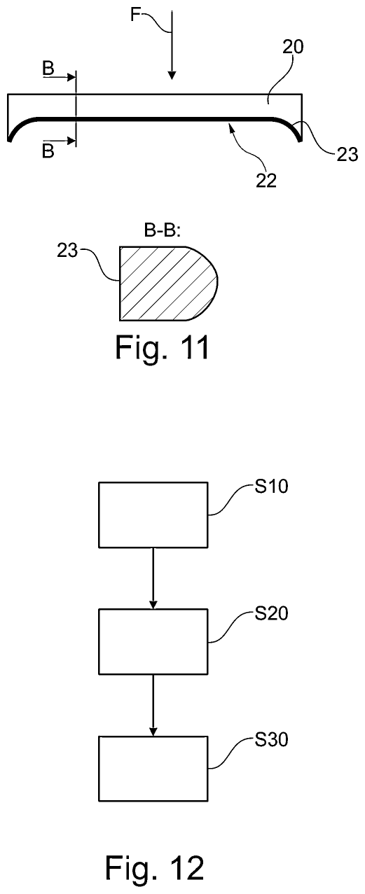

FIG. 11 shows a tool 20 for producing the card body 10 from FIG. 7 and a corresponding cross section of the tool 20. The tool 20 may have a die with an embossing surface 22, with the embossing surface 22 here having a single projection 23, which ultimately creates the form of the single cutout 14, as shown in FIG. 7, in the card body 10. During the production process, the tool 20 may be moved toward the punched-out card body 10 and then pressed against the border of the card body 10. For this purpose, the force F indicated by the arrow is applied, whereby the projection 23 is pressed into part of the peripheral border 13 of the card body 10 (cf. FIG. 1). The projection 23 has here an elongate rounded shape, which can be seen in the sectional view B-B of FIG. 11. For example, the projection 23 is semicircular.

In FIG. 11, only one side of the tool 20 is shown by way of example. Four tools 20 may be provided, respectively creating the cutouts 14 in the border portions 13a, 13b, 13c, 13d. It is also possible however for two tools 20 to be provided, respectively positioned in an L shape around the card body 10 in such a way that one of the two tools 20 introduces a first subportion of the cutout 14 for example into the first border portion 13a and into the second border portion 13b and the other of the two tools 20 introduces a second subportion of the cutout 14 for example into the third border portion 13c and into the fourth border portion 13d (cf. once again FIG. 1).

During the production process, the tool 20 may be stationary and the card body 10 may be turned with respect to the tool 20. In this case, the card body 10 is moved up to the tool 20, in order to provide the structure predetermined by the projection 23 in the form of the cutout 14 in the card body 10. The form and the specific shaping of the cutout 14 are determined by the tool 20, in particular by the projection 23. The embossing may be performed cold in the production process, or the tool 20 may be heated or activated by ultrasound. This can make the embossing process easier.

FIG. 12 shows a flow diagram for a method for producing a data carrier in card form, for example for producing the data carrier 1 in card form from FIG. 1. In a step S10 of the method, provision of a card body 10 takes place, the card body having a first card surface 11, a second card surface 12 and a peripheral border 13, with the peripheral border 13 connecting the first card surface 11 to the second card surface 12. In a step S20 of the method, provision of at least one cutout 14 in a first border portion 13a of the peripheral border 13 takes place. In a step S30 of the method, introduction of a color material 15 into the at least one cutout 14 takes place, in order in this way to provide a color effect for the first border portion 13a.

The provision of the at least one cutout 14 in the first border portion 13a of the peripheral border 13 may take place during a punching out of the card body 10 from a semifinished card blank.

The provision of the at least one cutout 14 in the first border portion 13a of the peripheral border 13 may take place by means of a laser process or a milling process.

The introduction of the color material 15 into the at least one cutout 14 may take place by means of a printing process or a spraying process.

1. A data carrier in card form, comprising:
a card body, which has a first card surface, a second card surface and a peripheral border;
with the peripheral border connecting the first card surface to the second card surface;
with the peripheral border having a first border portion with at least one cutout;
with the at least one cutout being at least partially filled with a color material, in order in this way to provide a color effect for the first border portion.

2. The data carrier in card form as claimed in claim 1, wherein the at least one cutout is provided in the form of a depression in the first border portion, extending perpendicularly to the first card surface and/or the second card surface.

3. The data carrier in card form as claimed in claim 1, wherein the at least one cutout is provided in the form of a depression in the first border portion, extending from the first card surface to the second card surface.

4. The data carrier in card form as claimed in claim 1, wherein the at least one cutout is provided in the form of an elongate depression in the first border portion, extending parallel to the first card surface and/or to the second card surface.

5. The data carrier in card form as claimed in claim 1, wherein the at least one cutout has in a cross section parallel to the first card surface and/or to the second card surface a curved form, a rectangular form or a triangular form; and/or
wherein the at least one cutout has a cross section perpendicular to the first card surface and/or to the second card surface a curved form, a rectangular form or a triangular form.

6. The data carrier in card form as claimed in claim 1, wherein the at least one cutout is defined by a lowered part and two raised parts;
wherein the two raised parts are adjacent to the lowered part;
wherein the color material is provided at least in the lowered part.

7. The data carrier in card form as claimed in claim 1, wherein the first border portion has a multiplicity of cutouts, which are arranged at regular distances from one another along the first border portion;
wherein each cutout of the multiplicity of cutouts is at least partially filled with a color material, in order in this way to provide a color effect for the first border portion.

8. The data carrier in card form as claimed in claim 1, wherein the peripheral border has the first border portion, a second border portion, a third border portion and a fourth border portion;
wherein the first border portion lies opposite the third border portion with respect to the card body;
wherein the second border portion lies opposite the fourth border portion with respect to the card body.

9. The data carrier in card form as claimed in claim 8, wherein the at least one cutout extends along the first border portion, the second border portion, the third border portion and the fourth border portion.

10. The data carrier in card form as claimed in claim 1, wherein the color material is an ultraviolet-radiation-curing printing ink.

11. The use of a data carrier in card form as claimed in claim 1, wherein said use includes an identification document, an identity document, a chip card or a payment card.

12. A method for producing a data carrier in card form, comprising:
providing a card body, which has a first card surface, a second card surface and a peripheral border, with the peripheral border connecting the first card surface to the second card surface;
providing at least one cutout in a first body portion of the peripheral border;
introducing a color material into the at least one cutout, in order in this way to provide a color effect for the first border portion.

13. The method as claimed in claim 12, with the provision of the at least one cutout in the first border portion of the peripheral border taking place during a punching out of the card body.

14. The method as claimed in claim 12, wherein the provision of the at least one cutout in the first border portion of the peripheral border takes place by means of a laser process or a milling process.

15. The method as claimed in claim 12, wherein the introduction of the color material into the at least one cutout takes place by means of a printing process or a spraying process.
